(19) United States
(12) Patent Application Publication
(10) Pub. No.: US 2014/0025776 A1
(43) Pub. Date: Jan. 23, 2014

(54) GENERAL-PURPOSE FRAMEWORK FOR DELIVERING CUSTOM, LOCATION-BASED DATA TO MOBILE CLIENTS

(71) Applicant: Nicole S. Boden Salverda, Chicago, IL (US)

(72) Inventor: Nicole S. Boden Salverda, Chicago, IL (US)

(21) Appl. No.: 13/948,513

(22) Filed: Jul. 23, 2013

Related U.S. Application Data
(60) Provisional application No. 61/674,769, filed on Jul. 23, 2012.

(51) Int. Cl. G06F 15/163

(52) U.S. Cl. CPC G06F 15/163
USPC 709/217

(57) ABSTRACT

A computerized and mobile information processing system for providing and receiving location-based notices of events from publishers to subscribers of the system, each of said notices being customized by said publishers and selectively received only by subscribers interested therein and only when in proximity to at least one of said events. Notices can be transmitted to interested subscribers based either on their stated plans or on their actual locations and in accordance with either their stated interests or their mobile locations.

### PRIORITY CLAIM

This application claims the benefit of priority of the disclosure and claims of my copending provisional application for patent Ser. No. 61674769, filed on-line after 7 pm ET on Jul. 23, 2012.

### 1. FIELD OF THE INVENTION

A mobile device application and system acts as a personal concierge, providing registered users with detailed information on current local events in which the users have expressed interest.

### 2. BACKGROUND OF THE ART

This section surveys known applications and services that, one way or another, touch on some of the functions and features provided by the present invention. In so doing, it becomes clear that

### Direct Competitors

A number of companies provide a similar service to the present system, albeit in a different way. In fact, some of these companies offer services that are compatible with this system, so they can be viewed as potential affiliates rather than as competitors.

### Social Networking Sites

The closest direct competitors to this system are community-based web sites, such as Facebook, Google+, and Meetup. Like the present system, these have a discovery capability in that users can be proactively introduced to events via their social groups. However, those same social groups can also act as a filter because they prevent users from discovering (potentially interesting) events that fall outside the knowledge of their groups. The system is not subject to this constraint because its design is centered on topic-based interaction, not on group-or social-based interaction.

A closely related benefit of the topic-based framework is its ability to maintain anonymity, especially of subscribers. This is in contrast to social networking frameworks, where users must “like” another user or group (i.e. they must join a social group) before they can receive information shared by the associated members. It is important to note that members of a social group are known to each other.

Services like Facebook Events also embed location-aware functionality. But, again, because the Facebook architecture is centered on social groupings (Facebook Events are sent to a list of known invitees), it is not ideally suited to the immediate and unplanned discovery of proximate events. The system is built to serve precisely that need. It is more tailored and specialized in this respect, its architecture being centered on topics and locations, not on users' affiliations.

Another important difference is that subscribers curate their own interests directly: they manage their topic subscriptions themselves to determine which notifications they will be sent. This differs from the social graph data used broadly to infer a subscriber's interests, based on the interests of their Facebook or Google+ friends.

### Localized Search Engines

Yelp incorporates localized searching capabilities with user reviews. Offsetting its comprehensive user base is the fact that publishers and subscribers are locked into the Yelp network.

Also, all searches are pull-based in the sense that the user has to actively search for local information. In addition, search results are not updated in real time.

### Location-Aware Gaming

Some sites such as Foursquare and SCVNGR have incorporated the concept of rewards programs into location-aware mobile gaming sites. These applications require a person to check-in at certain locations to earn points or rewards, which increases that user's status in the application and eventually results in financial savings such as discounts or freebies. In the case of SCVNGR, people are required to complete set challenges at various locations to earn these rewards. SCVNGR offers the ability for a series of challenges to be posed at a sequence of locations, which is similar to the “routes” concept planned for the system (though the system will not enforce challenges at each stage in the route).

These sites offer a subset of what the system offers: The system allows anyone to publish, does not require challenges to be met, and is more general-purpose as to the events that can be published and how they can be tagged.

### Indirect Competitors

A number of web sites allow people to search for information about local events. Examples include:
Major search engines with local search, such as Google's localized search and Bing Local Scout;
Tourist board sites, travel web sites, and listings sites and publications, such as Time Out magazine's web site, the Chicago Tribune, Chicago Sun-Times, Metro mix, and the Chicago Reader;
Online classifieds sites such as Craigslist;
Community-based event sites;
Company web sites.

All of these allow users to learn about new events of interest, but they are essentially pull-based, in that users must (re-)initiate the search as and when they seek the information. Many of these sites would be excellent partners for the present system.

### SUMMARY OF THE INVENTION

The new system unifies a collection of features in a unique and user-friendly combination. Principal features include the following.
The system is mobile;
It is targeted to the subscriber's interests by means of user-selected tags;
It is targeted to the subscriber's location because it is location-aware and, hence, inherently hyper-local.
The system's notifications are distributed using a push-based framework;
Notifications are presented in real time, as subscribers move around a city or area;
The framework is general-purpose, in that notifications can embed whatever information the publisher wishes to communicate to subscribers;
The system spans many scales of use, in which individuals, small businesses or organizations, and large establishments can all publish notifications;
The system facilitates discovery by connecting otherwise mutually anonymous publishers and subscribers.

### THE PREFERRED EMBODIMENTS

At any one time, a large number of events are happening in a city: stores hold sales, restaurants have promotions, and art galleries host exhibits; there are music concerts, plays, wine tastings, and so on. It is cumbersome, however, for a person to find out about events that are of particular interest to him or her. Typically, one must spend time sifting through commercial emails, following postings on social sites such as Facebook, viewing web site postings, collecting flyers in the mail, etc.—to name just a few methods. The problem is exacerbated when traveling to another city, where local happenings are even harder to discover.

Those that host or sponsor events face an analogous problem, namely reliably reaching and thereby notifying people of their events. They must either resort to broad and expensive marketing campaigns, in the hopes of reaching the right people by “casting the net wide,” or they must rely on the right people discovering them by, for example, having them poll the appropriate web sites, social forums, and so on.

The present invention aims to solve these problems. The system is a mobile device application that acts as a concierge, providing users, such as subscribers to the service, with detailed information on current and local events. The system allows its subscribers to select tags, or keywords, to identify topics that fall within their domain of interest. A centralized service then sends them notifications about events that are associated with those same keywords.

The subscriber's mobile device presents these notifications to the user in a manner that is determined by the user's current location: those events closest to the user are shown more prominently. The system thus acts as a radar, or spotlight, exposing and drawing attention to events that are both interesting to the user (by virtue of their associated topics) and immediately accessible to the user (by virtue of their current proximity). This system thus allows the user to discover events within his immediate environment, including those organized or hosted by previously unknown event holders. Because the system updates the user's view of nearby events in real-time, it also allows the user to interact with his current environment in an unplanned, spontaneous fashion.

This system thus is a highly targeted way in which to notify interested people of events. It achieves this focus along three complimentary axes:
1. Event notifications are targeted in terms of content, in the sense that information about events reaches specifically those users that have, upfront, registered an interest in the associated topics.
2. Event notifications are targeted in geographical terms, in that they are displayed and organized based on the user's current location.
3. Notifications are targeted in time, since they are delivered, and remain valid, only for current and imminent events.

In short, this system is topic-, location-, and time-centric. It thereby achieves a degree of immediacy that is unique in its domain, and which will accordingly appeal equally to those wishing to send and to receive notifications.

Though it is highly targeted, a key feature of this system is its ability to provide mutual anonymity between those that send and those that receive notifications. Neither needs to know the existence of the other up front; rather, they connect solely by means of the topic they share in common. This capability distinguishes this system from other forms of targeted marketing, where sender and receiver must, one way or another, know of and establish a relationship between one another to be able to communicate.

The system is essentially a marketing tool, and it can accordingly generate revenue by charging a fee to the parties sending notifications. As part of its marketing service, the system can also provide feedback to senders on the effectiveness of their notifications, such as how many users receive them and via which topics.

In addition to the basic service-based revenue, the system can also generate revenue by partnering with event organizers and sponsors in the services they provide. For example, the system can work with vendors and booking agencies to be paid a percentage of sales generated, or a fixed fee per referral. This would allow those vendors to obtain more accurate feedback on the effectiveness of their notifications: for instance, they can track how many of them convert into sales.

In operation, the system allows registered publishers to deliver notifications to a multitude of registered, interested subscribers. On the publication side, the system comprises a web-based interface for registering as a user, and for defining and managing notifications. A centralized server system disseminates publishers' notifications to the appropriate subscribers. On the subscriber side, the system again provides a web-based interface for registering as a user and for defining and managing the set of topics in which the subscriber is interested. Subscribers then use a mobile device application to receive and view notifications as they move around. It may be desirable and possible also to include a screen on the mobile client that allows the user to register and manage user and topic registrations.

At its core, the system of the present invention comprises three main components: notifications, topics, and a mobile device application. The following sections discuss each of these in some detail.

### Notifications

A notification is a free-form message, prepared by a publisher, to be delivered to one or more subscribers. In this respect, it is roughly analogous to an email message, but it differs in one important respect: it is delivered to an unknown set of recipients. Notifications differ also in that they are annotated with the following:
1. one or more descriptive topic names (called tags); and
2. a geographical location; and
3. a time period for which they are applicable.

The tags are used by the system to identify the set of subscribers to which the notification will ultimately be delivered. Specifically, it is only those subscribers who have registered an interest in one or more of the notification's tags who will receive the notification on their mobile devices. The notification's relative geographical location determines how prominent the notification will appear on a subscriber's mobile device. Those notifications in closest proximity will move to the top of the various lists displaying notifications available to the subscriber.

### Tags

Tags are simple text strings (keywords) that can be associated with notifications, and which thereby establish a connection between publisher and subscriber in the system. They serve exactly the same function as the tags with which photographs are annotated in an application like Flickr.

It is important to note that tags are not associated directly with other people who are interested in a topic; instead, they are theme or topic-based. Tag subscriptions are anonymous in that no information about any subscribers to that tag is available, publicly or otherwise. In addition, the subscriber does not have to make public their interest in a tag in order to receive notifications for that tag.

### Mobile Device Applications

The mobile application is a network-enabled and location-aware application that displays notifications to the subscriber. It is the subscriber's primary interface to the present system.

The mobile application periodically polls the system server for new notifications available to this registered user. The server uses the mobile device's current location, and the user's tag subscription information, to determine which set of notifications are available for download. As time progresses, the mobile device accumulates a potentially large set of notifications through which the user can browse. Notifications do expire, so content does not grow indefinitely.

The primary goal of the mobile app is to organize notification content in a manner that facilitates quick and easy access to information that is of most interest to the user. Two main views on the notification content are defined for this purpose.
1. Proximity-centric view. This displays notifications that fall within a small, fixed radius (e.g. 1 mile, or, e.g., two city blocks) of the user's current location. Content is ordered by proximity, so notifications closest to the current location appear most prominently. The idea is to draw attention to events that are eminently accessible—those that are within short walking distance, for example.
2. Tag-centric view. This groups notifications based on the tags with which they have been associated. That is, this view allows the user to browse notifications by subject. For a given tag, the set of notifications are again ordered by proximity to the user's current location.

The functionality described above constitutes a mode of operation that is referred to as “Roaming Mode”. In this mode, the device's current location determines how content is organized and displayed. As that location changes—as the user roams—so too does the displayed content. Complementing this mode of operation is “Planning Mode”, in which the user is able to specify a fixed but remote location as the base point relative to which content is displayed. This allows the user to plan ahead—to discover events that might be of interest in and around an area into which they are about to travel, be it a different neighborhood or even an entirely different city.

The framework of the present system is able to expand in unanticipated ways, because
notifications are largely free-form, in the sense that very little structure is imposed on their content;
anyone (not just businesses) can publish notifications;
any tags can be associated with particular notifications;
anyone with registered interest in those tags can receive that notification; and
any location can be used as a base for receiving notifications.

The system is “open”, in a sense, having the potential to expand and evolve organically, responding to the uses that subscribers find for it.

The present system falls broadly within the domain of mobile advertising, a market that is increasingly moving towards real-time, hyper-local, targeted distribution of information. In this area, the system aims to meet the complementary needs of two distinct groups of people.
Publishers, who want to inform people about events—concerts, sales, or promotions, for example—that they or their affiliates are holding. They want to reach specifically those people who are sure to be interested in those events, be they existing or potential customers. They also want especially to target people as and when they are in proximity to their event.
Subscribers, who want to discover current and upcoming events that are of interest to them, especially those that are located close to their current location. They may want to be spontaneous, so they might want to be notified about events real-time rather than have actively to seek out that information in advance. Equally, they may want to plan activities by being able to view events at a location they are about to visit.

The present system naturally connects these two groups of people. In so doing, it distinguishes itself by maintaining mutual anonymity between publishers and subscribers: they do not know of each other up front, but they are nevertheless able to discover each other via the system's topic-based publication infrastructure. In addition, subscribers are not made public to each other. This systemic anonymity is an important feature in the increasingly public world of internet-based applications.

The mobile application itself meets another important need in that it integrates the processes of learning about and planning for events, and incorporating that information into personal schedules. It allows users, for example, to plan their activities by adding event details directly into their calendar.

Many variations may be made in the invention as shown and in its manner of use, without departing from the principles of the invention as described herein and/or as claimed as the invention. Minor variations will not avoid the use of the invention.

I claim as my invention:

1. A system for delivering custom, location-based data to subscribers' mobile devices, the system comprising:
a server, a publisher, and a plurality of subscribers, each of said subscribers having a uniquely identified wireless mobile device having local time of day and geographic location-sensing and reporting capabilities;
the server being connected to means for communicating between the publisher and each of the subscribers' mobile devices;
the server accepting and storing at least one event or opportunity from said publisher to be made available to any of said subscribers, wherein each event or opportunity has topic, time, and location information associated with it;
the server also accepting and storing indications of interest in events and opportunities from each of said subscribers, each of said indications being categorized into one or more topics;
the server further having logic means for correlating each of the events and opportunities according to their topics, times, and locations as provided by said publisher to the indications of interest of each of said subscribers;
the server receiving real-time location and time of day data from at least one of said subscribers via that subscriber's mobile device and promptly correlating said one subscriber's interests and location data with the events and opportunities and their times and locations provided by said publisher; and
the server promptly identifying and communicating in real time at least to said one subscriber's mobile device each match between the one subscriber's stated interests and disclosed location and the stored events and opportunities provided by the publisher for said time and location of the subscriber.

2. The system as defined in claim 1, further comprising the step of operating selectively in either of a Tag-Centric mode, in accordance with stated subscriber interests, and a Proximity-Centric mode, in accordance with subscriber location.

3. The system as defined in claim 1, further comprising the step of operating selectively in one of a Roaming Mode and a Planning Mode for each subscriber's access to future or to distant events.
